(19) United States
(12) Patent Application Publication
(10) Pub. No.: US 2019/0041249 A1
(43) Pub. Date: Feb. 7, 2019

(54) DRIVE AND CONTROL DEVICE FOR A THROUGHFLOW MEASUREMENT DEVICE

(71) Applicant: AVL LIST GMBH, GRAZ (AT)

(72) Inventor: OTFRIED DERSCHMIDT, GRAZ (AT)

(73) Assignee: AVL LIST GMBH, GRAZ (AT)

(21) Appl. No.: 16/072,882

(22) PCT Filed: Jan. 27, 2017
(86) PCT No.: PCT/EP2017/051770

§ 371 Date: Jul. 26, 2018

(30) Foreign Application Priority Data
Jan. 29, 2016 (AT) A46-2016

(51) Int. Cl. G01F 3/10

(52) U.S. Cl. CPC G01F 3/10

(57) ABSTRACT

A drive and control device for a throughflow measurement device. The drive and control device includes an electric drive unit, a connection housing connected to the electric drive unit, a main board, and an attachment structure to position the main board with respect to the electric drive unit. The attachment structure includes at least one board retaining element to which the main board is attached, and an attachment element to which the electric drive unit is attached. The attachment element includes guide rails which position the at least one board retaining element when the at least one board retaining element is pushed onto the guide rails.

### CROSS REFERENCE TO PRIOR APPLICATIONS

This application is a U.S. National Phase application under 35 U.S.C. § 371 of International Application No. PCT/EP2017/051770, filed on Jan. 27, 2017 and which claims benefit to Austrian Patent Application No. A46-2016, filed on Jan. 29, 2016. The International Application was published in German on Aug. 3, 2017 as WO 2017/129745 A1 under PCT Article 21(2).

### FIELD

The present invention relates to a drive and control device for a throughflow measurement device with an electric drive unit, a connection housing which is connected to the electric drive unit, a main board, and an attachment structure via which the main board is positioned with respect to the electric drive unit, wherein the attachment structure has an attachment element to which the electric drive unit is attached.

### BACKGROUND

Throughflow measurement devices are used, for example, for determining injected fluid amounts of injection valves in internal combustion engines. These throughflow rate measurement devices comprise an electric-motor-operated displacement meter in the form of a gear pump which is arranged, in the form of a piston disposed in a piston chamber, in parallel to a differential pressure transducer, wherein the gear pump is driven so that the differential pressure is compensated for at the differential pressure transducer, i.e., no differential pressure is produced across the piston.

It is accordingly necessary to drive the drive and control unit of the gear pump therefor. The drive and control unit is composed of an electric drive unit as well as the associated main board via which the signals of the electric motor can be received, for example, the power supply of the stator can be performed according to the required control signals or the processing of the data of the throughflow measurement device can be performed. Depending on the application, different data may must accordingly be transmitted to the main board or be processed therein, wherein, in this case, further boards may have to be connected to the main board to provide a correct data exchange. It is also necessary to protect the overall throughflow measurement device from contamination from outside so that the portion constituting the drive and control device is normally arranged under a hood which should be configured to be as small as possible in order to save installation space.

It is accordingly necessary to establish a reliable mechanical and possibly an electrical connection between the main board and the drive unit which is adapted to be manufactured in a simple manner with any installation faults being prevented which has a long service life so that the position of the main board and the electric drive unit under the hood remains unchanged even in the case of shocks so that reliable electric connections can be established. Good accessibility to the main board for power supply purposes and/or for connection to further boards must also be provided.

Attachment structures may be used for providing the above to which both the main board and the electric drive unit are attached since the relative position of these components with respect to each other is thus defined and it is provided that the hood can be put in place in a simple manner. This positioning additionally provides that in the area of the electrical connections, which may be configured as easy-to-install plug connections, no tensile forces or the like can occur which may lead to disconnection of these connections.

CN 204423922 U describes an actuator comprising an attachment structure to which both the electric motor and the main board are attached via screw connections. At the board, a plug and/or an electric connector for power supply purposes extend outwards and are screwed to the attachment structure from outside. The manufacture of this disclosed attachment structure is, however, very complex and the installation and the electrical connection are difficult. A contact between an outer housing to be additionally installed and the board cannot be reliably avoided during installation. A definition of the position relative to an additional external device is not intended.

### SUMMARY

An aspect of the present invention is to provide a drive and control unit for a throughflow rate measurement device where errors are avoided during installation, various devices can be connected in a simple manner so that they are easy to access, and reliable and durable connections can be established. An aspect of the present invention is at the same time to establish a reliable routing of the connection to the external devices, in particular to additional boards. An aspect of the present invention is to further provide a trouble-free and reliable installation of a protective hood over the electric drive unit and the main board without precluding the possibility of additionally connecting an additional connection box.

In an embodiment, the present invention provides a drive and control device for a throughflow measurement device. The drive and control device includes an electric drive unit, a connection housing connected to the electric drive unit, a main board, and an attachment structure configured to position the main board with respect to the electric drive unit. The attachment structure comprises at least one board retaining element to which the main board is attached, and an attachment element to which the electric drive unit is attached. The attachment element comprises guide rails which are configured to position the at least one board retaining element when the at least one board retaining element is pushed onto the guide rails.

### BRIEF DESCRIPTION OF THE DRAWINGS

The present invention is described in greater detail below on the basis of embodiments and of the drawings in which:

FIG. 1 shows a perspective view of a drive and control device according to the present invention during installation;

FIG. 2 shows a perspective view of the retaining element of the drive and control device according to the present invention of FIG. 1;

FIG. 3 shows a perspective view of the board retaining element of the drive and control device according to the present invention of FIG. 1 with an inserted main board;

FIG. 4 shows a perspective view of the drive and control device according to the present invention of FIG. 1 during the last installation step; and

FIG. 5 shows a perspective view of the connection box illustrated in FIG. 4 from an angle of view opposite to that of FIG. 4.

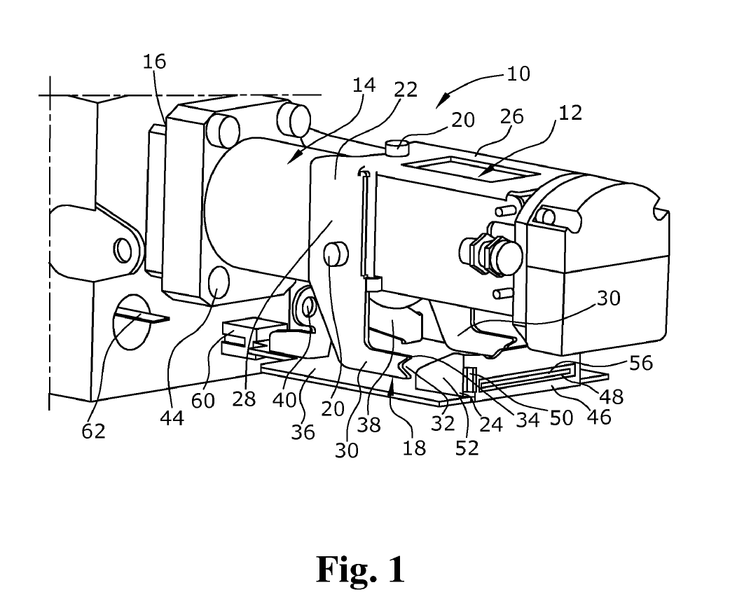

### DETAILED DESCRIPTION

Due to the fact that the attachment structure comprises a board retaining element to which the main board is attached and which is pushed onto guide rails formed at the attachment element for positioning purposes, the main board can initially be correctly aligned with respect to the electric drive unit and be installed so that it is easy to access and to then define its position with respect to the electric drive unit without any additional screwing operations at the board being necessary. A durable mechanical connection to the electric drive unit is accordingly established by a simple push-on operation. Installation errors are reliably avoided and it is possible to place a hood over the electric drive unit and the main board without the risk of contact between the main board and the hood which might lead to damage.

In an embodiment of the present invention, the first attachment element can, for example, comprise a connection plate from whose lateral ends two side plates extend in parallel to each other, at whose ends facing away from the connection plate, the guide rails extend in parallel to each other away from the connection housing and at an angle to the side plates. After attachment to the drive unit, the board retaining element can thus be simply slipped onto the guide rails, wherein the main board extends in parallel to the electric drive unit. The slipping-on operation is performed from the free side towards the connection housing.

In an embodiment of the present invention, the electric drive unit can, for example, be attached between the side plates. It is thus located in a space which, in cross-sectional view, is delimited by the connection plates, the side plates, and the board retaining element. Besides the easy-to-realize reliable retaining of the drive unit, the attachment structures serve as a protection when the hood is put in place, with the former serving as a guide for the latter.

The board retaining element can, for example, comprise a connection plate which extends from the main board vertically to the main board towards the drive unit and in which two openings are formed which are shaped so that they correspond to the guide rails that are inserted through the openings. This configuration clearly defines the plane of attachment of the main board to the electric drive unit. Due to this horizontal insertion by defined guiding, a plug element of the board extending rearwards may be plugged into a corresponding plug at the connection housing in the direction of which the board retaining element is slipped onto the guide rails. The guide rails, together with the openings at the connection plate, define the lateral position of the board retaining element and, via their axial position and their resting against the main board, additionally prevent a tilting movement so that only a movement along the guide rails is possible.

For a simple attachment of the main board to the board retaining element, the board retaining element comprises retaining bars which penetrate the main board and via which the main board is attached to the board retaining element.

In an embodiment of the present invention, the connection plate can, for example, comprise a connection opening which is shaped so that it corresponds to a plug located directly behind the connection opening so that electrical contacting to an opposite plug can be established through the connection opening. A connection box comprising a plug can accordingly be electrically connected to the main board in a simple manner from the free side facing away from the connection housing.

In an embodiment of the present invention, an attachment plate can, for example, extend in parallel to the connection plate, which is attached to the main board and which, after having been pushed onto the guide rails, is adapted to be screwed to the connection housing. Due to this screwing operation, the axial fixing of the main board can be performed in a simple manner after the board retaining element has been slipped on.

In an embodiment of the present invention, beside the openings of the connection plate for accommodating the guide rails, two bars can, for example, extend in parallel to the guide rails which extend from the connection plate. These two bars serve as a guide for the guide rails to reliably guide them into the openings. In particular in an embodiment of the attachment structure made from a normal bent steel sheet, an increased rigidity of the board retaining element is also achieved and a larger surface for attaching the board retaining element to the main board is provided.

In an embodiment of the present invention, a connection box accommodating one or a plurality of boards can, for example, comprise a plug corresponding to the plug of the main board and to the connection opening of the board retaining element and two positioning openings via which the connection box is positioned with respect to the board retaining element via the ends of the guide rails projecting through the openings of the connection plate of the board retaining element. The guide rails accordingly not only serve to position the main board with respect to the drive unit, but also for positioning further electric connection elements with respect to the main board so that a plurality of components are positioned with respect to each other by the guide rails.

In an embodiment of the present invention, one or a plurality of tips can, for example, be formed at the ends of the guide rails projecting through the openings of the connection plates, and the corresponding openings of the connection plate and/or the corresponding positioning openings of the connection box have an opening cross-section enlarged as compared with the dimension of the tips at the level of the tips, while the remaining opening cross-section of the openings and/or positioning cross-sections correspond to the cross-section of the guide rails. This enlarged opening allows for a simpler insertion of the guide rails into the corresponding openings via the tips. Upon further insertion of the guide rails into the openings, however, an adequate strength of the connection is established since, beside the enlargement, the area of the opening rests against the guide rails in a clearance-free manner.

A drive and control device for a throughflow measurement device is thus provided where installation errors are reliably avoided. The main board is also fixedly positioned and easy to access in order to establish further electrical connections or to connect external devices. A reliable guide for positioning the main board in a surrounding housing and, at the same time, a guide of external devices to be connected are provided. An additional protective hood can be pushed over the electric drive unit and the main board without the risk of damage since the attachment structure also serves as a protective covering and guide during installation.

The drive and control device for a throughflow measurement device according to the present invention is described below on the basis of an exemplary embodiment which is illustrated in the drawings and which is not intended to be understood to be limiting.

The drive and control device according to the present invention comprises an electric drive unit 10 which, in the present exemplary embodiment, is composed of an electric motor 12 with a magnetic coupling 14 connected thereto whose drive shaft projects through a connection housing 16 into a displacement chamber of a gear pump whose drive gear wheel is attached to the drive shaft.

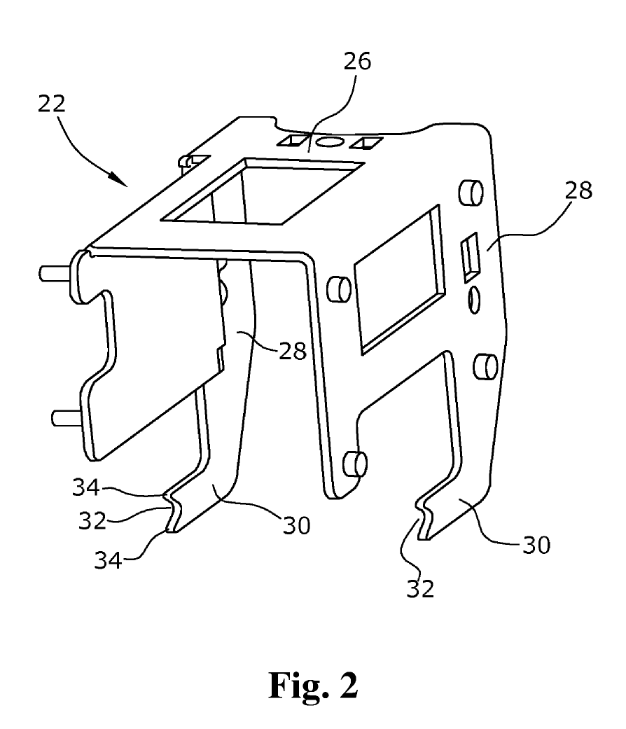

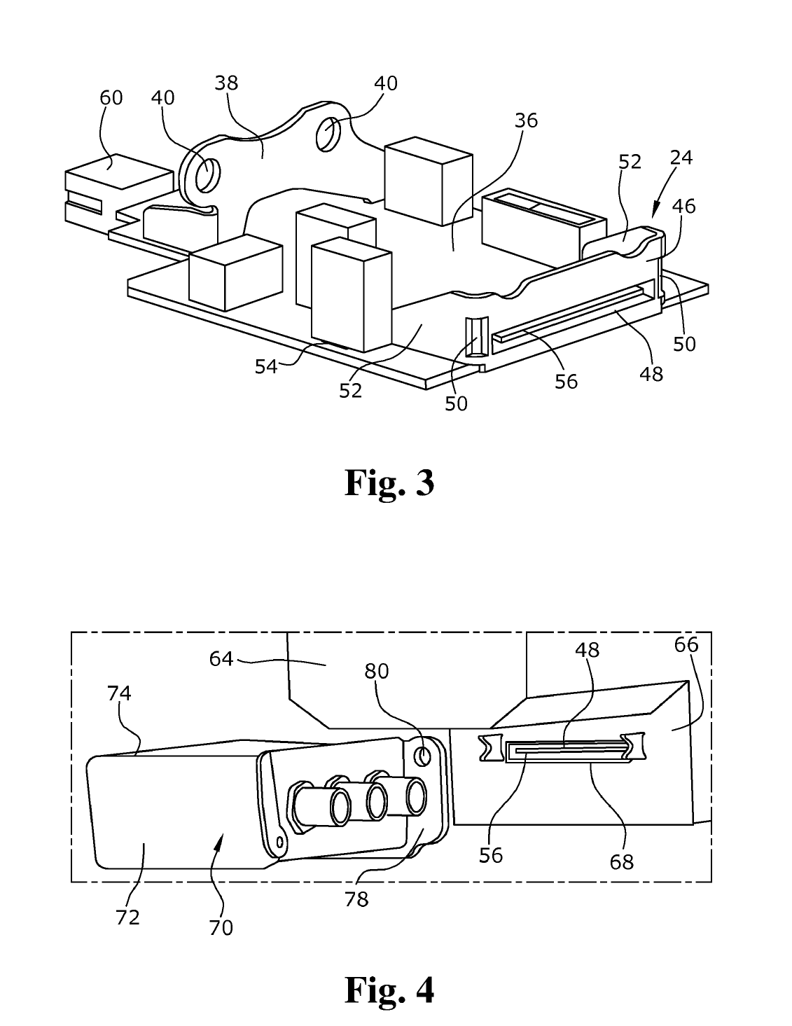

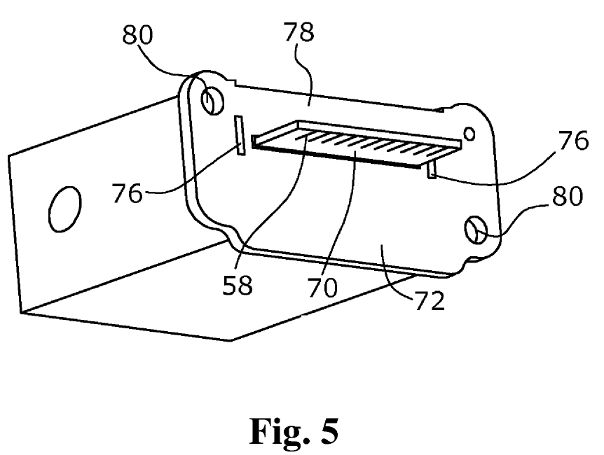

An attachment structure 18 is attached to the drive unit 10 via screws 20, which is composed of an attachment element 22 (shown in FIG. 2) and a board retaining element 24.

The attachment element 22 comprises a connection plate 26 from whose lateral ends a respective side plate 28 extends vertically to the connection plate 26 and in parallel to the respective other side plate 28. The connection plate 26 and the two side plates 28 accordingly surround the drive unit 10 from three sides via an axial portion. Guide rails 30 are formed at the ends of the sides plates 28 remote from the connection plate 26, which extend in parallel to the extension of the connection plate 26 as well as in parallel to the center axis of the drive unit 10 and vertically to the extension direction of the side plates 28 as seen from the connection plate 26 and facing away from the connection housing 16. These guide rails 30 comprise a triangular recess 32 at their ends facing away from the connection housing 16 so that a tip 34 is formed in the lower and upper areas of each guide rail 30.

A main board 36 which may be suitable for both the control of the drive unit 10 and the electronic evaluation of the measured values of the throughflow measurement device connected to the drive unit has an elongated shape with two longitudinal sides and two transverse sides. An attachment plate 38 extends at the first end of the main board 36 vertically to the main board 36 along its first transverse side, the attachment plate 38 having two bores 40 through which screws can be screwed into threaded bores 44 of the connection housing 16. On the opposite transverse side remote from the connection housing 16, the board retaining element 24 also extends vertically to the main board 36, which comprises a connection plate 46 that is arranged in parallel to the attachment plate 38. The connection plate 46 comprises a connection opening 48 which extends in parallel to the main board 36 as well as two elongated openings 50 arranged laterally beside the slit-shaped connection opening 48 and extending vertically to the main board 36, which elongated openings 50 are configured larger at their top and bottom ends. Directly beside the elongated openings 50, two bars 52 extend vertically to the connection plate 46 towards the connection housing 16 and/or to the attachment plate 38 which, together with the connection plate 46, form the board retaining element 24. From the attachment plate 38 as well as from the connection plate 46 and the bars 52, a plurality of retaining bars 54 extend through the main board 36, via which they are connected to attachment plate 38 and the board retaining element 24 at least in a form-fit manner.

The main board 36 comprises a plug 56 at its end facing the connection plate 46 which is configured as a flat plug and directly rests against the connection opening 48 so that a mating plug 58 for the plug 56 can be plugged into the plug 56 through the connection opening 48 for establishing an electrical connection. Another plug element 60 extends towards the connection housing 16 on the opposite side of the main board 36.

The installation is performed so that first the attachment element 22 is screwed to the drive unit 10, and the board retaining element 24 as well as the attachment plate 38 are connected to the main board 36 via the retaining bars 54. The main board 36 is then axially pushed, from the side opposite to the connection housing 16, onto guide rail 30 and towards the connection housing 16. The bars 52 rest from outside against the guide rails 30, and the main board 36 rests from below against the guide rails 30 so that a guided axial movement is realized on all sides. When a pushing of the main board 36 is maintained, the tips 34 of the guide rails 30 reach the openings 50 which have an enlarged cross-section at their upper and lower ends so that the tips 34 are inserted into the openings 50 without encountering any major resistance, while the remaining cross-section of the openings 50 corresponds to the cross-section of the guide rails 30. The pushing of the main board 36 is continued towards the connection housing 16 until the attachment plate 38 rests against the connection housing 16 and can be screwed-on there, and the plug element 60 extends to another board through a bore 62 in the connection housing 16, on which board a position sensor of a piston of a throughflow measurement device may, for example, be arranged. This insertion movement is completely guided by the guide rails 30 resting against the main board 36 as well as the shape of the openings 50 corresponding to the cross-section of the guide rails 30. The arrangement of the attachment plate 38 at the connection housing 16 is also clearly defined so that the main board 36 need not be supported during the attachment operation. In this state the ends of the guide rails 30 extend considerably beyond the connection plate 46. A movement of the main board 36 to the drive unit 10 is no longer possible.

After these installation steps, a cover hood 64 is pushed over the drive and control unit and against the connection housing 16, which cover hood 64 comprises at a wall surface 66 facing away from the connection housing 16 at least one recess 68 through which the ends of the guide rails 30 extend and through which the plug 56 is accessible.

Depending on the type of the drive unit 10 and the throughflow measurement device, a plurality of further boards 70 may then be connected to the main board 36 from outside via the plug 56, and the main board 36 and the electric motor 12 may be supplied with power. A connection box 72 may be used for this purpose in which these further boards 70 are arranged and at whose end facing the main board 36 the mating plug 58 projects from a housing 74 of the connection box 72. Two positioning openings 76 are also formed at the connection box 72 which are arranged and shaped in compliance with the guide rails 30 so that the connection box 72 can be pushed onto the ends of the guide rails 30 for the purpose of prefixing and correct aligning with the plug 56. A flange area 78 resting against the axially delimiting wall surface 66 of the cover hood 64 and from which the mating plug 58 also projects and in which the positioning openings 76 are formed laterally protrudes beyond the connection box 72 and comprises, in this protruding area, two bores 80 via which the connection box 72 is screwed to the cover hood 64.

From the connection box 72, which is freely accessible from four sides in the installed state, further electric contacting elements can extend outwards via which the further boards 70 can be connected and supplied with power.

The described drive and control device is easy to install. Installation errors are in particular reliably avoided. The main board is fixedly positioned in the drive and control unit and protected by a cover hood but is still easy to access for electrical contacting purposes in order to establish further electrical connections or to connect external devices and boards for an intelligent control. Reliable guiding for fixedly positioning the main board in a surrounding housing and, at the same time, for guiding external devices to be connected is provided. The cover hood additionally placed over the drive unit and the main board can be put in place without the risk of damage since the attachment structure also serves as protective covering and guide during installation.

It should be appreciated that the present invention is not limited to the described exemplary embodiment and that various modifications are possible. The drive and control unit can in particular be used for various applications. It is also conceivable to configure the attachment structure, and in particular the board retaining element, in a different way. The attachment plate and/or the connection plate can, for example, be configured as extending from a base plate against which the main board rests. Further different configurations are also conceivable. Reference should also be had to the appended claims.

What is claimed is:

1-10. (canceled)

11. A drive and control device for a throughflow measurement device, the drive and control device comprising:
an electric drive unit;
a connection housing connected to the electric drive unit;
a main board; and
an attachment structure configured to position the main board with respect to the electric drive unit, the attachment structure comprising,
at least one board retaining element to which the main board is attached, and
an attachment element to which the electric drive unit is attached, the attachment element comprising guide rails which are configured to position the at least one board retaining element when the at least one board retaining element is pushed onto the guide rails.

12. The drive and control device as recited in claim 11, wherein the attachment element further comprises a connection plate which comprises lateral ends from which a respective side plate extends in parallel to each other, each respective side plate comprising ends which face away from the connection plate and on which a respective guide rail extends in parallel to each other away from the connection housing and at an angle to the respective side plate.

13. The drive and control device as recited in claim 12, wherein the electric drive unit is attached between the respective side plates.

14. The drive and control device as recited in claim 11, wherein the at least one board retaining element comprises retaining bars which are configured to penetrate the main board and via which the main board is attached to the at least one board retaining element.

15. The drive and control device as recited in claim 11, wherein the at least one board retaining element comprises a connection plate which is configured to extend from the main board vertically to the main board towards the electric drive unit, the connection plate comprising two openings which are configured so that one of the respective guide rails is insertable through one of the respective two openings.

16. The drive and control device as recited in claim 15, further comprising:
an attachment plate attached to the main board, the attachment plate being configured to extend in parallel to the connection plate and to be screwed to the connection housing after having been pushed onto the guide rails.

17. The drive and control device as recited in claim 15, wherein the connection plate further comprises two bars extending therefrom, each of the two bars being arranged beside a respective one of the two openings to extend in parallel to the guide rails.

18. The drive and control device as recited in claim 15, wherein,
the connection plate further comprises a connection opening,
the main board comprises a plug which is arranged directly behind the connection opening, and
the connection opening is configured to correspond to the plug so that an electrical contacting to the plug can be established through the connection opening.

19. The drive and control device as recited in claim 18, further comprising:
a connection box configured to accommodate at least one board, the connection box comprising,
a mating plug which is configured to correspond to the plug of the main board and to the connection opening of the at least one board retaining element, and
two positioning openings which are arranged to position the connection box with respect to the at least one board retaining element via a respective end of a respective guide rail extending through a respective one of the two openings of the connection plate of the at least one board retaining element.

20. The drive and control device as recited in claim 19, wherein,
each of the guide rails comprises an end which comprises at least one tip, and at least one of,
the two openings of the connection plate, and
the two positioning openings of the connection box,
comprise an opening cross-section which is enlarged compared to a dimension of the at least one tip at a level of the at least one tip, while a remaining opening cross-section of at least one of,
the two openings, and
the two positioning openings,
corresponds to a cross-section of the guide rails.
